(19) United States
(12) Patent Application Publication
(10) Pub. No.: US 2007/0233816 A1
(43) Pub. Date: Oct. 4, 2007

(54) Digital media management system and method

(76) Inventor: Michael J. Odenwald, Pipersville, PA (US)

Correspondence Address: Thomas J. McWilliams;Reed Smith LLP, 2500 One Liberty Place, 1650 Market Street, Philadelphia, PA, 19103, US

(21) Appl. No.: 11/397,322

(22) Filed: Apr. 4, 2006

(51) Int. Cl. G06F 15/16

(52) U.S. Cl. 709/219

(57) ABSTRACT

A system and method for managing digital media data files owned by a user via a network are disclosed. The system and method include at least one processor and at least one database, communicatively connected to the at least one processor, for storing at least one data file, and at least one computing device, remote from the at least one processor and communicatively connected to the at least one processor via a network. The at least one computing device is capable of uploading the at least one data file and subsequently accessing selected ones of the at least one data file, where the user provides a first information item relating to the at least one computing device to the at least one processor. The system and method also include at least one information provider, remote from the at least one processor and communicatively connected to the at least one processor via the network, wherein the at least one information provider provides a second information item relating to the at least one computing device and based on the first information to the at least one processor, where the at least one processor manages the access to the selected ones of the at least one data file by the at least one computing device based on the first and second information items.

### FIELD OF THE INVENTION

The invention relates to managing digital media collections, and, more particularly, to a system and method for improved storage, management and delivery of digital media files via a global network.

### BACKGROUND OF THE INVENTION

Currently, there are a variety of media play applications available for playing and organizing digital media files. These applications typically interface with a handheld device, such as a digital audio player, or other various computing devices containing programming to manage and play digital music files. Such applications may also include connections to on-line stores to allow users to purchase digital media, such as music files, that can be played by a handheld device in conjunction with the applications. Some applications profess a reputation for being easy to use and for having enhanced user interfaces, while continuing to provide many features for obtaining, organizing, and playing music. The applications are sometimes free to download from the internet and may be bundled with the computer's or hand-held device's software. Many such applications are compatible with standard forms of computer operating systems, including Mac OS X, Windows® 2000, Windows® XP, and Windows® Server 2003.

Currently, users may add music files to the application from existing compact discs, music files residing on a computer, or by purchasing and downloading music files over the internet. Some applications can organize music files by artist, theme, category, date, or other characteristic of music. In certain instances, when more than one music file has been added to an application, an application may allow users to create music libraries and manage the music files therein. For example, some applications allow users to manage music files by creating a list of music files (or playlist), adjusting random playback of songs, and/or setting parental controls. In addition, some applications have features which allow users to edit the music's file information, record compact discs, copy the music files to a digital audio player, or run a visualizer to display graphical effects in time to the music being played, as well as encode music into a number of different audio formats.

Many current applications have different playback features, which may be customizable by the user. In many cases, users can create playlists according to their own preferences, which can be saved and then played immediately or at a later time. In other cases, some applications' playlist-creation function can be set to automatically update like a database query, based on a customized list of selection criteria. Users can enter different criteria to control different aspects of the playlist, such as the artist or genre of the music. Some applications allow users to choose from a selection of playback modes, including by playlist, by artist, or by genre playback, for example. Additionally, some applications may allow users to choose between random or sequential playback. In such cases, applications allow for the “randomness” of the playback function to be biased for or against playing multiple songs from the same album or artists in sequence or to select songs randomly from other playlists, or from the library.

Some applications allow synchronization of hand-held devices with music file content (such as music libraries and playlists) on various forms of computers. In this case, new songs and playlists may be automatically copied to the hand-held device, and songs which have been deleted from the library on the computer may also be deleted from the hand-held device. In some instances, applications allow automatic synchronization to be turned off in favor of manually copying individual music files or complete playlists.

However, as society produces more and more kinds of electronic device functions, a need for electronic device consolidation has pushed many of the features of hand-held devices, such as such as calling, emailing, paging, an other networked functions into “all in one” devices. Because of this, devices such as wireless phones, which can also play music and connect to the internet, are fast becoming the preferred hand-held device, at the expense of simple music players. This movement to “all in one” wireless phones also creates a premium for storage space resident on the phone, which will typically be used primarily for storing programming and other data necessary to phone functionality. Currently, cellular telephones have the capabilities of storing limited amounts of files, displaying (in black and white or color) pictures and text, connecting to the internet, and playing music. Designers of multifunctional wireless phones are also incentivized to keep resident storage space down, as use of large amounts of resident storage and the programming surrounding such use may cause the phone to constantly run hot and thus create functional problems from overheating, or may cause excessive battery use and thus undesired fast run-down.

Because the aforementioned media play applications require large amounts of storage resident on the hand-held device, these applications, and the music management systems surrounding such applications, are quickly becoming obsolete. Also, while some cellular phones are capable of holding a limited number of music files, no system exists for providing an immediate and continuous link to a user's full collection of music files. Thus, a need exists to combine the capabilities of a hand-held digital media player with the capabilities of a cellular phone in such a way that only one device is needed to both communicate and access and manage a large collection of music files.

### SUMMARY OF THE INVENTION

The present invention described includes a system and method for managing digital media data files owned by a user via a network. The system and method include at least one processor and at least one database, communicatively connected to the at least one processor, for storing at least one data file, and at least one computing device, remote from the at least one processor and communicatively connected to the at least one processor via a network. The at least one computing device is capable of uploading the at least one data file and subsequently accessing selected ones of the at least one data file, where the user provides a first information item relating to the at least one computing device to the at least one processor. The system and method also include at least one information provider, remote from the at least one processor and communicatively connected to the at least one processor via the network, wherein the at least one information provider provides a second information item relating to the at least one computing device and based on the first information to the at least one processor, where the at least one processor manages the access to the selected ones of the at least one data file by the at least one computing device based on the first and second information items.

Also described is a system for displaying lyrics to prerecorded music during play of the prerecorded music via a network. The system includes at least one processor and at least one database, communicatively connected to the at least one processor, for storing a plurality of prerecorded music files, at least one information provider, remote from the at least one processor and communicatively connected to the at least one processor via a network, where the at least one information provider provides at least lyrics corresponding to selected ones of the plurality of prerecorded music files at the request of the at least one processor, and at least one computing device, remote from the at least one processor and communicatively connected to the at least one processor via a network, where the at least one processor provides access to selected ones of the plurality of prerecorded music files and the corresponding lyrics for both playing the selected ones of the plurality of prerecorded music files and viewing the corresponding lyrics simultaneously on the at least one computing device.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 is a schematic diagram of the overall system components according to the present invention;

FIG. 2 is a schematic diagram of the central server of FIG. 1;

FIG. 3 is a flowchart outlining a method of managing digital media files based on the system of FIG. 1; and

FIG. 4 is a schematic diagram of a karaoke system using the method of FIG. 3.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in digital media management systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

In an exemplary embodiment of the present invention, a computerized network may be used not only to upload digital media files to remote storage for future access, but also for distributing additional data or information relating to the uploaded digital files from a central location to any number of end-users or devices located remotely from the central location. Such files may be any sort of file suitable for containing multimedia content, such as the most current versions of JPEG, MPEG, MOV, WAV, AVI or MP3, to name just a few.

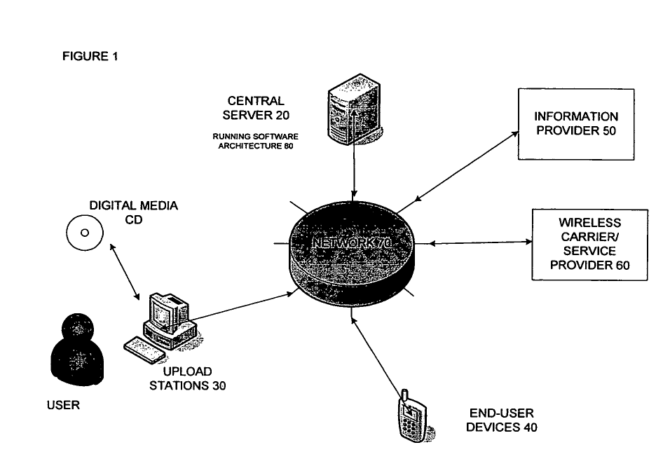

As may be seen in FIG. 1, system 10 may generally include a central server 20, upload stations 30, end-user devices 40, information providers 50, wireless carrier/service providers 60, and wide area network 70.

Central server 20 may include specialized software architecture 80 (described below) and may be run by a system 10 administrator or administration staff, and may include at least one processor, standard input and output devices, as well as all hardware and software typically found on computing devices for storing data and running programs, and for sending and receiving data over a network. Central server 20 may be one server or, more preferably, a combination of scalable servers, providing functionality as a network mainframe server, a web server, a mail server and central database server, all maintained and managed by the system 10 administrator. Central server 20 may also be connected directly or via a network to remote databases, such as for additional storage backup. Central server 20 may be connected to any number of upload stations 30, end-user devices 40, information providers 50, and wireless carrier/service providers 60, all via a wide area network 70, such that wide area network 70 allows for the communication of files, email, software, and any other data format between central server 20 and upload stations 30, end-user devices 40, information providers 50, and wireless carrier/service providers 60. Additionally, the system administrator may add any number of servers or other necessary hardware and software to central servers 20, such that system 10 may provide efficient and reliable service for local upload stations 30 and end-user devices 40, as the number of upload stations 30 and end-user devices 40 may increase.

Upload stations 30 may be one or more of any sort of computing device suitable for uploading a digital media file to central server 20 via wide area network 70. For example, such computing device may be a personal computer (“PC”), a personal digital assistant (“PDA”), a laptop, a wireless digital/cellular phone, or the like. In an exemplary embodiment, upload station 30 may be a kiosk situated near a digital music or video retail store, or may simply be a home computer owned by the purchaser of a musical compact disc (“CD”). Upload stations 30 may also form part of or otherwise be connected to any sort of local area network such as, for example, a local wireless network within a user's home or within a retail store or office building.

End-user devices 40, like upload stations 30, may be one or more of any sort of personal computing device, such as a desktop PC, a laptop, a PDA, or, more preferably, a wireless digital/cellular phone, for example, such that end-user devices 40 may be communicatively connected to central server 20 via wide area network 70. While end-user devices 40 may also be connected to a preexisting calling network provided by one of the many existing wireless phone service providers, such multi-network connectivity should not interfere with the wireless phone's connection to system 10 via wide area network 70. It should also be understood that, while upload stations 30 and end-user devices 40 have been thus far described as separate entities, a single device may operatively function as both upload station 30 and end-user device 40 at different points in time.

Information providers 50 may provide additional information or data related to any sort of digital media that is publicly or commercially available. For example, such information or data may be song lyrics, advertisements, information about artists, complementary digital media in the form of still frame, video or audio, real-time news or updates, or any other information that may be related to particular digital media. This information or data may be in any format transferable over wide area network 70, and may be requested or accessed by central server 20 as needed or as agreed to between managers of both central server 20 and information provider 50.

For example, advertisers wanting to reach the public may first provide the central processor 20 with content in the form of a computer readable file according to a set of specifications for such files to conform to. These specifications may define a particular file format or formats that may be relatively simple for advertisers or other information providers to meet, and the process of central server 20 for incorporating the files into accessible data for User may be simplified.

Information provider 50 may also assist central server 20 in digital music identification and recognition for both compact discs and individual music files through system 10. Multi-step recognition methods may enable system 10 to identify, categorize, and/or organize stored digital music. Automated and scalable computer-based analysis of the audio waveforms of individual songs using digital signal processing techniques may objectively determine musical characteristics such as tempo, timbre, rhythm, instrumentation, harmony, melody, and/or structure of individual songs. Once music is identified, music-related information and/or content may be obtained from information provider 50. Such incorporation of information from information provider 50 may allow for the generation of recommendations for music, music videos, and other music-related merchandise that users may be interested in. The number and variety of recommendations may be tailored before they are presented to a user either by information provider 50, central server 20, or by the user of system 10.

Wireless carrier/service providers 60 may be any digital or cell phone provider that offers digital and cell phone plans to the public. Wireless carrier/service providers 60 simply need be communicatively connected to wide area network 70, such that central server 20 may request and receive information from the particular wireless phone service provider to which end-user device 40 receives phone service from. Once the particular wireless phone service provider 60 has been identified, that service provider 60 may provide information to central server 20 relating to phone type of end-user devices 40, as well as the type of calling plan used by the owner (or user) of end-user device 40.

Wide area network 70 may be any suitable networked system understood by those having ordinary skill in the art, such as, for example, an open, wide area network (e.g., the internet), an electronic network, an optical network, a wireless network, a physically secure network or virtual private network, and any combinations thereof. Wide area network 70 may also include any intermediate nodes, such as gateways, routers, bridges, internet service provider networks, public-switched telephone networks, proxy servers, firewalls, and the like, such that wide area network 70 may be suitable for the transmission of data throughout system 10.

An encryption standard may also be used to protect files from unauthorized interception over the network. Any encryption standard or authentication method as may be understood by those having ordinary skill in the art may be used at any point in system 10. For example, encryption may be accomplished by central server 20 encrypting the output file by using a Secure Socket Layer (SSL) with dual key encryption, since a high degree of security may be desired by some of the information providers, copyright owners, and Users alike. Additionally, system 10 may limit, for example, data manipulation, or information access. For example, a system 10 administrator may allow for administration at one or more levels, such as at an individual user level, or at a system level. The system 10 administrator may also implement access or use restrictions for users at any level. Such restrictions may include, for example, the assignment of user names and passwords that allow the use of the present invention, or the selection of one or more data types that the subservient user is allowed to view or manipulate.

Further, wide area network 70 may also use standard architecture and protocols as understood by those skilled in the art, such as, for example, a packet switched network for transporting information and packets in accordance with a standard transmission control protocol/Internet protocol (“TCP/IP”). Central server 20, upload stations 30, end-user devices 40, information providers 50, and wireless carrier/service providers 60 may be communicatively connected into wide area network 70 through, for example, a traditional telephone service connection using a conventional modem, an integrated services digital network (“ISDN”), a cable connection including a data over cable system interface specification (“DOCSIS”) cable modem, a digital subscriber line (“DSL”), a T1 line, or any other mechanism as understood by those skilled in the art. Additionally, system 10 may utilize any conventional operating platform or combination of platforms, and may utilize any conventional networking and communications software as needed.

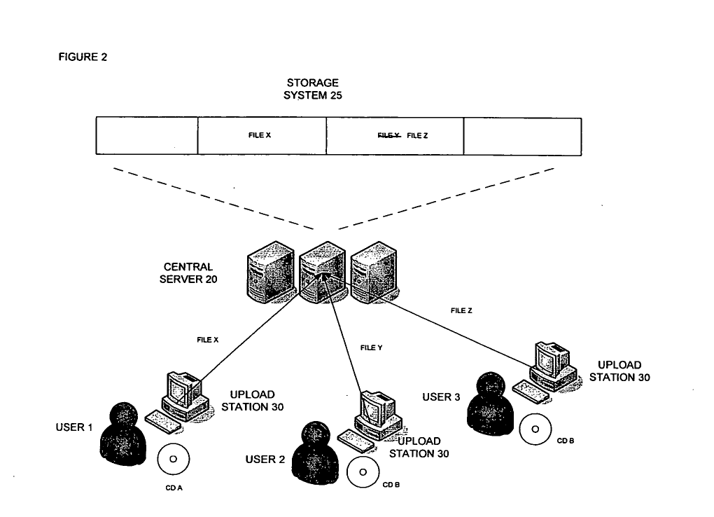

Referring now to FIG. 2, a more detailed description of central server 20 is provided. A person, such as User 1, who purchases digital media, such as a musical CD, such as “CD A”, from a retail store, for example, may use upload station 30 to upload musical CD A file in a compressed and optimal file format as determined by central server 20 and designated herein as “file X”, to central server 20. Central server 20 receives uploaded file X and stores it in a database storage system 25, a portion of which is designated as a “lock box”, holding those files owned and stored by User 1. Alternatively, central server 20 may store all digital media uploaded in a generalized master database system, and further create and manage digital media file lists for each user, such that central server 20 may recognize and match each User with their uploaded files, and allow access to only those files owned or uploaded by each particular user.

In the above described exemplary embodiment, each file uploaded may be stored separately and independently from all other uploaded files. In an alternative embodiment of central server 20, central server 20 may, prior to storing an uploaded file for a particular user, check to see if a file identical to the uploaded file has already been stored in database storage system 25. If a previous version of the uploaded file has not already been stored in database storage system 25, central server 20 may store the uploaded file for the user. If a previous version of the uploaded file was already stored in database storage system 25, central server 20 may simply designate the user uploading the file as having access to the previously stored file, and replace the old version of the stored file with the most recent copy only if deemed necessary. For example, as shown in FIG. 2, multiple users, depicted as Users 1, 2 and 3, may upload digital media, such as a musical CDs A and B, purchased at retail stores by Users 1, 2 and 3, where User 1 purchased CD A and Users 2 and 3 each purchased their own copies of CD B. Each User uploads their purchased CD at an upload station 30 at different points in time, where the CDs are compressed and uploaded sequentially to central server 20 as files X, Y and Z, representative of the CDs purchased by Users 1, 2 and 3, respectively. Assuming that User 3 is the last User to upload his or her copy of CD B, when User 3 uploads file Z (the compressed version of CD B), central server 20 recognizes that previously uploaded file Y (also a compressed version of CD B) is already stored in storage system 25, replaces stored file Y with the more recent file Z, and designates both Users 2 and 3 as having access to file Z. Central server 20 may also recognize a file designated for upload as a copy of a previously stored file prior to actual uploading, and simply give access to the previously stored file to the user. Such recognition by central server 20 prior to uploading may be based on instruction by the user, or by recognition of the file designated for upload via an encoded “tag” forming part of the file or associated with the file, or by any other mechanism understood by those skilled in the art.

Individual user accounts may be established to manage, track and to customize information or to target information or promotional material to particular users or set of users. System 10 may also include a registration system, such that, if the User has previously visited and entered and set up a user account, meaning particular information, such as an identifier, has been saved in the system, system 10 may acknowledge this fact, and simply apply information provided by the User in the previous registration. Individual email accounts may also be established via software architecture 80, or previously existing email accounts may be associated with individual user accounts to allow system 10, information providers 50, wireless carrier/service providers 60, or other organizations participating in system 10 to send email messages to any particular user or group of users.

System 10 further includes application software architecture 80, which may be managed by central server 20. Software architecture 80 may include a software framework that optimizes ease of use of at least one existing software platform, and that may also extend the capabilities of at least one existing software platform. The application architecture may approximate the actual way users organize and manage digital media files, and thus may organize use activities in a natural, coherent manner while delivering use activities through a simple, consistent, and intuitive interface within each application and across applications. The architecture may also be reusable, providing plug-in capability to any number of applications, without extensive re-programming, which may enable parties outside of system 10 to create components that plug into the architecture. Thus, software or portals in the architecture may be extensible and new software or portals may be created for the architecture by any party.

Software architecture 80 may provide, for example, applications accessible to one or more users to perform one or more functions. Such applications may be available at the same location as the user, or at a location remote from the user. Each application may provide a graphical user interface (GUI) for ease of interaction by the user with information resident in system 10. A GUI may be specific to a user, set of users, or type of user, or may be the same for all users or a selected subset of users. Software architecture 80 may also provide a master GUI set that allows a user to select or interact with GUIs of one or more other applications, or that allows a user to simultaneously access a variety of information otherwise available through any portion of system 10.

Software architecture 80 may be a portal that provides, via the GUI, remote access to and from the present invention. Software architecture 80 may include, for example, a network browser, as well as a media player. Software architecture 80 may include the ability, either automatically based upon a user request in another application, or by a user request, to “hook”, search, or otherwise retrieve particular data from one or more remote points, such as on the internet. Software architecture 80 may vary by user type, or may be available to only a certain user types, depending on the needs of system 10. Users may have some portions, or all of software architecture 80, resident on uploading stations 30 or end-user devices 40, or may simply have linking mechanisms, as understood by those skilled in the art, to link uploading stations 30 or end-user devices 40 to software architecture 80 running on central server 20 via wide area network 70. As such, any device having, or having access to, the software architecture 80 may be capable of uploading, or downloading, any media files, or informational files to be associated with such media files. In one exemplary embodiment, such linking mechanisms may be included as part of or in association with a purchased digital media file, such as an additional “non-musical” track on the music CD, so that when the music CD is loaded into uploading station 30, the user is automatically granted, or simply invited, to access software architecture 80 resident on central server 20 of system 10. Software architecture may also be provided separately and/or run separately on any upload station 30 or end-user device 40, providing all functionality applicable to such devices as may be appropriate until actual connection to wide area network 70 (and consequently central server 20) is achieved.

Presentation of data through software architecture 80 may be in any sort and number of selectable formats. For example, a multi-layer format may be used, wherein additional information is available by viewing successively lower layers of presented information. Such layers may be made available by the use of drop down menus, tabbed pseudo-manila folder files, or other layering techniques understood by those skilled in the art. Formats may also include AutoFill functionality, wherein data may be filled responsively to the entry of partial data in a particular field by the user. All formats may be in standard readable formats, such as XML. Software architecture 80 may further incorporate standard features typically found in media play applications, such as, for example, a front or “main” page to present a user with various selectable options for use or organization of media files. In one exemplary embodiment, selectable buttons may permit a user to view or listen to prerecorded music, video, or even play games, for example, and choose or organize their media files based on any sort of category, such as rock, country, jazz, or pop for music files, or comedy, horror, or action, for video files. A listener may also have the option to search or browse for media by standard or customized categories. Further, software architecture may allow other information related to their stored digital media files that may be of interest to users, and may graphically display any portion of such information either as a separate window, or by any other mechanism understood by those skilled in the art. Software architecture 80 may also support a live streaming broadcast of uploaded songs, or any sort of “live feed” streamed to end-user device 40, such as live radio, television, real-time stock quotes, and the like. Because end-user device 40 may typically be a mobile device, such as a wireless phone, streaming data may be passed throughout wide area network 70 as needed between towers, any by any other method understood by those skilled in the art. Software architecture 80 may also support any sort of interactive purchasing platform, where a user may receive advertisements and purchase items from system 10 or from any third party connected to system 10 via wide area network 70.

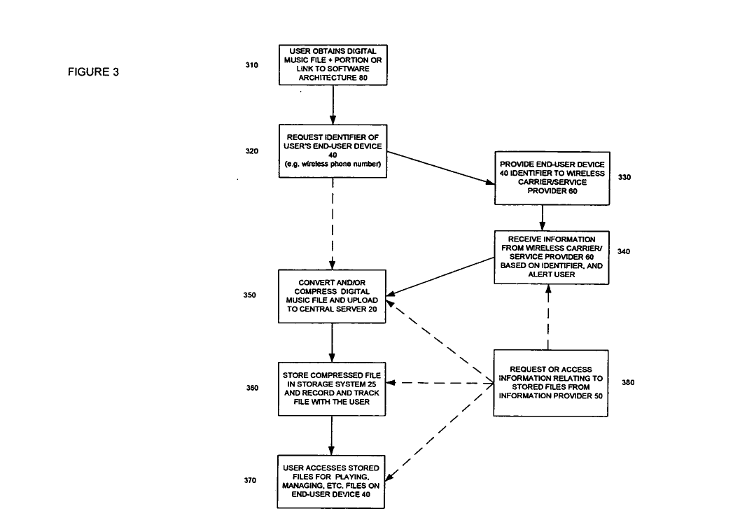

As mentioned previously, the present invention also includes a method 300 of managing and playing digital media files, and is illustrated generally in FIG. 3. For example, in step 310, a User may obtain at least one digital media file in the form of a music CD, having encoded thereon either a link to software architecture 80 run on system 10, or all or any portion of software architecture 80. The User may load or otherwise run the CD on upload station 30, which may be the User's home PC having a CD drive therein, for example, but which may also be any device capable of both reading all the files on the CD and connecting to wide area network 70. For example, upload station 30 may alternatively be the User's wireless phone, which the User may have used to purchase a digital music file online and downloaded to the storage resident on the wireless phone. Such digital music files may be obtained by the User in a multitude of ways such as, for example, purchasing the CD at a brick-and-mortar retail store, or downloading the digital music directly to upload station 30 via the internet from a website or on-line music store. In yet another example, a User may already own a tape, record, or digital file, and need simply to convert the file to a format suitable for use by system 10, and then either already have or separately obtain the necessary link to or portion of software architecture 80, such as by separate download from the internet to upload station 30, or by separate purchase or gift from a retail store selling digital media, and subsequently loaded onto upload station 30.

At step 320, central server 20 may prompt the User for an identifier of the User's end-user device 40. If end-user device is the User's wireless phone, for example, such identifier could be, by way of non-limiting example, the phone number of the wireless phone. In this example, the wireless phone may be associated or otherwise have active service as separately contracted with a wireless phone service provider, designated herein as one of wireless carrier/service providers 60.

Next, at step 330, central server 20 may provide the identifier to wireless carrier/service provider 60 to obtain additional information relating to the type of phone identified by the User and the calling plan associated with that particular phone. Central server 20 may store this and any other collected information pertaining to the User in a separate user file. Upon receiving such additional information from wireless carrier/service provider 60 (regarding the User's phone, or end-user device 40), at step 340, central server 20 alerts the User at upload station 30 whether the User's phone is compatible with system 10. If the system is compatible, central server 20 may offer any form of payment or service plan for system 10, which may be accepted or denied by the User. If the User's phone is not compatible, central system 20 may provide to the User information regarding what can be done to make that phone and or calling plan compatible, make offers or suggestions to purchase a new phone and/or plan, or link in other third party retailers, such as other phone service carriers and phone manufacturers, who may advertise and/or make offers to the User via system 10 for selling products compatible with system 10. Alternatively, method 300 may move directly from step 320 to step 350, and have steps 330 and 340 occur between steps 360 and step 370, described below.

At step 350, the User may upload the digital music file from upload station 30 to central server 20 via wide area network 70. This step may further include software architecture 80 to convert and compress the digital music file into a format suitable for transfer and storage to central server 20. Alternatively, software architecture 80 may instruct applications resident on upload station 30 to perform the necessary file conversion and compression.

Once the digital media file has been uploaded to central server 20, at step 360, central server 20 may identify, record and track the file in association with the User and other files previously stored, and optimize its usage of storage space in storage system 25 as described previously with regard to FIGS. 2a and 2b.

At a later point in time, in step 370, the User may connect to system 10 from end-user device 40 for accessing the user's digital media files previously uploaded to central server 20. As described previously, the User may be presented with a multitude of options, such as playing, organizing, creating or sending the digital media files and/or any other information relating to the digital media files. Such options may include, by way of non-limiting examples, to play or transfer the User's music via download, streaming, or remote accessing, buy additional music, create and/or store playlists of music, and/or organize music. It should be understood that because upload station 30 and end-user device 40 may be interchangeable, the User may, for example, perform these same options from a different device, such as his or her home PC, and create playlists or other file compilations for future access from the User's wireless phone. Also, as mentioned previously, central server 20 may alternatively perform steps 330 and 340 where the User connects to system 10 at end-user device 40. For example, the User may receive an alert from central server 20 that, while communication with system 10 occurs, some or all of the features of system 10 may not be compatible with the User's phone, and thus steps 330 and 340 may proceed as previously described, and lead into step 370.

At step 380, which may occur in conjunction with any of steps 330, 340, 350, 360 and 370, central server 20 may incorporate, either by request from the User or by software architecture 80 recognition or logic, identify information related or complementary to stored digital media files and request such information from information provider 50. Such information may be requested, incorporated and/or selected for access by a User from end-user device 40. For example, upon request from a User at step 370, central server 20 may query information provider 50 for searchable news, information, recommendations, or lists associated with a particular digital media file, artist or any other feature selected by the User.

The above described method provides many points at which a User may be billed or otherwise charged a fee for use of system 10, although there is no requirement to charge any particular fees at particular points in method 300. For example, inclusion of separate programming or linking to software architecture 80 may be independently chargeable at a point of sale, or may have a fee added to the manufacturing costs of CDs, or other portable storage of digital media. Additionally, fees may be assessed by central server 20 at step 330 or 340, as described above. Further, fees may be assessed and recorded in a User Account system, where usage of system 10 may be billed by any billing mechanism as understood by those skilled in the art. For example, payments for uploading or downloading media files may be transacted via known electronic financial transaction methods such as by credit card, debit card, or regular postal mail.

According to another aspect of the present invention, the uploaded digital media files may be used for more than easy listening. For example, any media file, such as a popular song or home recording, may be uploaded to a User's wireless phone and function as a ring tone. This system therefore provides vastly superior recordings of music or any other feature desired for a ring tone than compared to what may be commercially available.

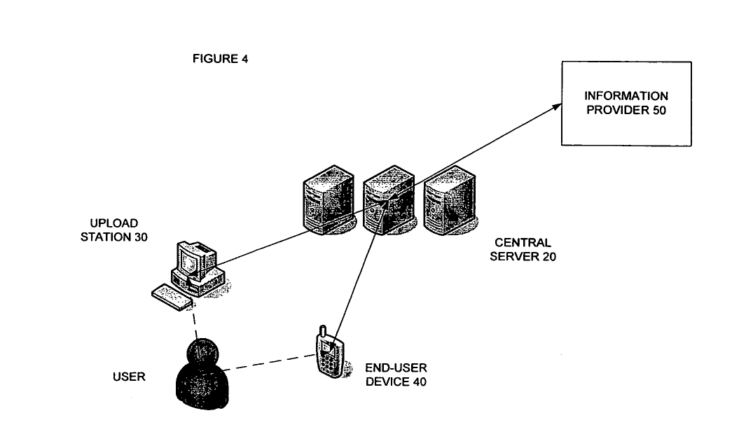

In another aspect of the present invention, a system and method of obtaining music files and data files relating to the music file is described. By way of non-limiting example, such a system 400 may be used for playing karaoke on end-user devices 40, and is illustrated in FIG. 4. For example, after a User has uploaded a digital music file from upload station 30 of a popular song for storage at central server 20, the User may, at end-user device 40, select “Karaoke” from a set of selectable options provided through software architecture 80, and further selecting the song identified for performing the karaoke. Upon selection of the song by the User, central server 20 either accesses or requests the lyrics of the selected song from information provider 50. Information provider 50 sends or allows access to a file corresponding to the lyrics, where such file may be in a format easily convertible or compatible with the song file held by central server 20. Information provider 50 may also provide a version of the song where there are no vocals, for combination with the lyrics file to better create the karaoke experience. Alternatively, information provider 50 may have specialized “karaoke files” in which the song and visual lyrics are prefabricated into a single file. Central server 20 may then prepare both the song file and the lyrics file in such a way that the User may access and play both files simultaneously, allowing the User on end-user device 40 to both play the song file and view the lyrics at the same time. This simultaneous play may occur as different functions running in multiple windows, or the files may be converted or otherwise merged together by central server 20 by any method understood by those skilled in the art, to form a new single and separate file playable from end-user device 40. Additionally, if end-user device is one that may create recordings, such as either audio or both audio and video, the User may record the karaoke, meaning the song and User's voice overlay, and subsequently upload the recording to central server 20 in the same manner as previously described herein.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A system for managing digital media data files, owned by a user, over a network, comprising:
at least one processor;
at least one database, communicatively connected to said at least one processor, for storing at least one data file;
at least one computing device, remote from said at least one processor and communicatively connected to said at least one processor via the network, wherein said at least one computing device is capable of uploading said at least one data file and subsequently managing selected ones of said at least one data file, wherein said user provides a first information item relating to an accessibility of said at least one computing device to said at least one processor;
at least one service provider, remote from said at least one processor and communicatively connected to said at least one processor via said network, wherein said at least one service provider provides a second information item, relating to a capability of said at least one computing device in accordance with said first information item, to said at least one processor; and
wherein said at least one processor allows remote access to certain of said selected ones of said at least one data file by said at least one computing device based substantially on said first and second information items.

2. The system of claim 1, wherein said at least one computing device comprises a wireless phone.

3. The system of claim 2, wherein said first information item is a phone number.

4. The system of claim 2, wherein said at least one data file accessed by said wireless phone is operative as a ringtone for said wireless phone.

5. The system of claim 2, wherein said at least one information provider is a wireless phone carrier providing service to said wireless phone.

6. The system of claim 1, wherein said at least one data file provides instructions to said at least one computing device to link to said at least one processor via said network.

7. The system of claim 1, wherein said at least one data file comprises an audio file.

8. The system of claim 1, further comprising a second information provider, wherein said second information provider provides information, via said network, relating to at least one of said at least one data files to said at least one processor and subsequently accessible by said at least one computing device from said at least one processor.

9. The system of claim 8, wherein said information provided by said second information provider comprises advertising material.

10. A method of managing digital media data files over a network, comprising:
providing a first information item relating to at least one computing device to at least one processor located remotely from said at least one computing device via a network;
uploading, via said network, at least one data file from said at least one computing device to said at least one processor;
requesting, by said at least one processor via said network, a second information item relating to said at least one computing device and based on said first information item, from an information provider; and
downloading selected ones of said at least one data file based by said at least one computing device, wherein said at least one processor manages said downloading and other accessing by said at least one computing device based on said first and second information items.

11. The method of claim 10, wherein said at least one computing device comprises a wireless phone.

12. The method of claim 11, wherein said first information item is a phone number.

13. The method of claim 11, wherein said at least one data file downloaded by said wireless phone is operative as a ringtone for said wireless phone.

14. The method of claim 11, wherein said at least one information provider is a wireless phone carrier providing service to said wireless phone.

15. The method of claim 10, wherein said at least one data file provides instructions to said at least one computing device to link to said at least one processor via said network.

16. The method of claim 10, wherein said at least one data file comprises an audio file.

17. The method of claim 10, further comprising requesting, by said at least one processor via said network, a third information item relating to at least one of said at least one data file, from a second information provider, wherein said at least one processor provides access to said third information item to said at least one computing device.

18. The method of claim 17, wherein said third information item provided by said second information provider comprises advertising material.

19. A system for displaying lyrics to prerecorded music during play of the prerecorded music via a network, comprising:
at least one processor and at least one database, communicatively connected to said at least one processor, for storing a plurality of prerecorded music files;
at least one information provider, remote from said at least one processor and communicatively connected to said at least one processor via a network, wherein said at least one information provider provides at least lyrics corresponding to selected ones of said plurality of prerecorded music files at the request of said at least one processor;
at least one computing device, remote from said at least one processor and communicatively connected to said at least one processor via a network, wherein said at least one processor provides access to selected ones of said plurality of prerecorded music files and said corresponding lyrics for both playing said selected ones of said plurality of prerecorded music files and viewing said corresponding lyrics simultaneously on said at least one computing device.

20. The system of claim 19, wherein said at least one computing device comprises a wireless phone.
